(19) United States
(12) Patent Application Publication
(10) Pub. No.: US 2015/0153184 A1
(43) Pub. Date: Jun. 4, 2015

(54) SYSTEM AND METHOD FOR DYNAMICALLY FOCUSING VEHICLE SENSORS

(71) Applicant: GM GLOBAL TECHNOLOGY OPERATIONS LLC, Detroit, MI (US)

(72) Inventors: UPALI PRIYANTHA MUDALIGE, OAKLAND TOWNSHIP, MI (US); SHUQING ZENG, STERLING HEIGHTS, MI (US); MICHAEL LOSH, ROCHESTER HILLS, MI (US)

(73) Assignee: GM GLOBAL TECHNOLOGY OPERATIONS LLC, Detroit, MI (US)

(21) Appl. No.: 14/096,638

(22) Filed: Dec. 4, 2013

(51) Int. Cl. G01C 21/26

(52) U.S. Cl. CPC G01C 21/26

(57) ABSTRACT

Methods and systems for dynamically prioritizing target areas to monitor around a vehicle are provided. The system, for example, may include, but is not limited to a sensor, a global positioning system receiver, and a processor communicatively coupled to the sensor and the global positioning system receiver. The processor is configured to determine a location of the vehicle and based upon data from the global positioning system receiver, determine a projected path the vehicle is traveling upon, prioritize target areas based upon the determined location, heading and the projected path, and analyze data from the sensor based upon the prioritized target areas.

### TECHNICAL FIELD

The technical field generally relates to vehicles, and more particularly relates to vehicular safety systems.

### BACKGROUND

Vehicle safety systems exist which can warn a driver of a potential event or automatically take control of a vehicle to brake, steer or otherwise control the vehicle for avoidance purposes. In certain instances, massive amounts of data must be analyzed in order to activate these systems, which can cause delays.

Accordingly, it is desirable to provide systems and methods for dynamically focusing vehicle sensors. Furthermore, other desirable features and characteristics of the present invention will become apparent from the subsequent detailed description and the appended claims, taken in conjunction with the accompanying drawings and the foregoing technical field and background.

### SUMMARY

A method for dynamically prioritizing target areas to monitor around a vehicle is provided. The method may include, but is not limited to determining, by a processor, a location of the vehicle and a path the vehicle is traveling upon, prioritizing, by the processor, target areas based upon the determined location and path, and analyzing, by the processor, data from at least one sensor based upon the prioritizing.

In accordance with another embodiment, a system for dynamically prioritizing target areas to monitor around a vehicle is provided. The system may include, but is not limited to, a sensor, a global positioning system receiver, and a processor communicatively coupled to the sensor and the global positioning system receiver. The processor is configured to determine a location of the vehicle and based upon data from the global positioning system receiver, determine a projected path the vehicle is traveling upon, prioritize target areas based upon the determined location and the projected path, and analyze data from the sensor based upon the prioritized target areas.

### DESCRIPTION OF THE DRAWINGS

The exemplary embodiments will hereinafter be described in conjunction with the following drawing figures, wherein like numerals denote like elements, and wherein:

FIG. 1 is a block diagram of a vehicle, in accordance with an embodiment;

FIG. 2 is a flow diagram of a method for operating an object perception system, such as the object perception system illustrated in FIG. 1, in accordance with an embodiment; and

FIG. 3 is an overhead view of an intersection, in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

As discussed in further detail below, a system and method for dynamically focusing vehicle sensors is provided. The sensors may provide a vehicular safety system with the information needed to either warn a driver of an event or to activate an automated safety system to help steer, brake or otherwise control the vehicle for avoidance purposes. As described in further detail below, the system identifies areas around a vehicle where a possible event for avoidance is most likely to come from. The system then prioritizes data analysis of the identified areas to minimize the amount of time needed to recognize a potential event.

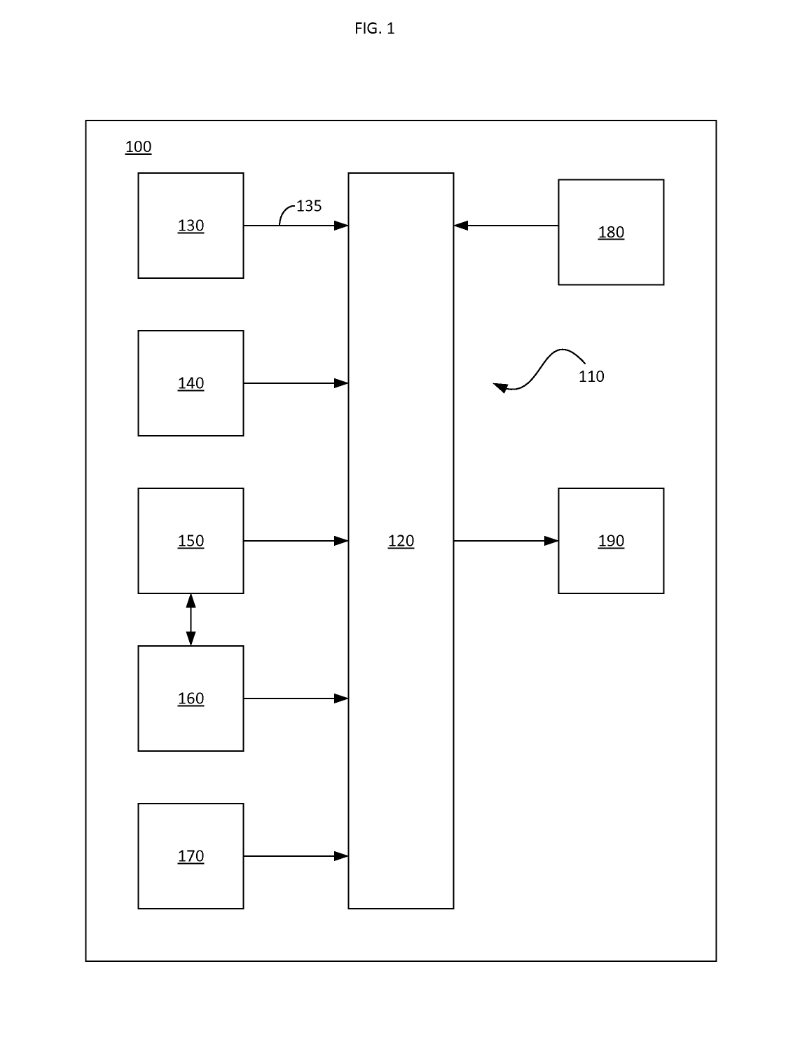

FIG. 1 is a block diagram of a vehicle 100 having an object perception system 110, in accordance with one of various embodiments. In one embodiment, for example, the vehicle 100 may be an automobile, such as a car, motorcycle or the like. However, in other embodiments the vehicle 100 may be an aircraft, a spacecraft, a watercraft, a motorized wheel chair or any other type of vehicle which could benefit from having the object perception system 110. Further, while the object perception system 110 is described herein in the context of a vehicle, the object perception system 110 could be independent of a vehicle. For example, the object perception system 110 could be an independent system utilized by a pedestrian with disabilities, a pedestrian utilizing a heads up display, or a fully or semi-autonomous robot, especially those using a vehicular-type chassis and locomotion.

The object perception system 110 includes a processor 120. The processor 120 may be, for example, a central processing unit (CPU), a graphics processing unit (GPU), a physics processing unit (PPU), an application specific integrated circuit (ASIC), a field programmable logic array (FPGA), a microprocessor, or any other type of logic unit or any combination thereof, and memory that executes one or more software or firmware programs, and/or other suitable components that provide the described functionality. In one embodiment, for example, the processor 120 may be dedicated to the object perception system 110. However, in other embodiments the processor 120 may be shared by other systems in the vehicle 100.

The object perception system 110 further includes at least one sensor 130. The sensor(s) 130 may be an optical camera, an infrared camera, a radar system, a lidar system, ultrasonic rangefinder, or any combination thereof. The vehicle 100, for example, may have sensors 130 placed around the vehicle such that the object perception system 110 can locate target objects, such as other vehicles or pedestrians, in all possible directions (i.e., 360 degrees) around the vehicle. The sensor(s) 130 are communicatively coupled to the processor 120 via, for example, a communication bus 135. The sensor(s) 130 provide data to the processor 120 which can be analyzed to locate target objects, as discussed in further detail below.

In one embodiment, for example, the object perception system 110 may include a vehicle-to-vehicle (V2V), vehicle-to-infrastructure (V2I), vehicle-to-pedestrian (V2P) communication capable radio system 140. Such radio systems 140 allow vehicles, infrastructure and pedestrians to share information to improve traffic flow and safety. In one example, vehicles can transmit speed, acceleration and navigation information over the V2V radio system 140 so that other vehicles can determine where the vehicle is going to be and determine if there are any potential overlaps in a projected path each vehicle is travelling.

The object perception system 110 may further include a navigation interface 150. In one example, the navigation interface 150 may be included in a dashboard of the vehicle 100 and allow a user to input a destination. It should be noted that the navigation interface 150 can be located at any other location within the vehicle 100, and further, that the functionality provided by the navigation system 110 could be received from a portable electronic device in communication with a system of the vehicle 100. The processor 120, as discussed in further detail below, may use the destination information to determine a projected path and to determine target areas for the sensor(s) 130.

The navigation interface 150 and processor 120 may be communicatively coupled to a memory 160 storing map data. The memory 160 may be any type of non-volatile memory, including, but not limited to, a hard disk drive, a flash drive, an optical media memory or the like. In another embodiment, for example, the memory 160 may be remote from the vehicle 100. In this embodiment, for example, the memory 160 may be stored on a remote server or in any cloud based storage system. The processor 120 may be communicatively coupled to the remote memory 160 via a communication system (not illustrated). The communication system may be a satellite communication system, a cellular communication system, or any type of internet based communication system. The map data may store detailed data on road surfaces, including, but not limited to, the number of lanes on a road, the travelling direction of the lanes, right turn lane designations, left turn lane designations, no turn lane designations, traffic control (e.g., traffic lights, stop signs, etc.) designations for intersections, the location of cross walks and bike lanes, and location of guard rails and other physical barriers. The memory 160 may further include accurate position and shape information of prominent landmarks such as buildings, overhead bridges, towers, tunnels etc. Such information may be used to calculate accurate vehicle positioning both globally and relative to known landmarks, other vehicles and pedestrians.

The object perception system 110 further includes a global position system (GPS) 170. In one example, the global position system 170 includes a receiver capable of determining a location of the vehicle 100 based upon signals from a satellite network. The processor 120 can further receive GPS corrections from land-based and satellite networks to improve positioning accuracy and availability. Availability of landmark database will further enhance the vehicle positioning accuracy and availability. The processor 120 can receive GPS data from the global position system 170 and determine a path that the vehicle is traveling upon, the lane the vehicle 100 is traveling in, the speed the vehicle 100 is traveling and a variety of other information. As discussed in further detail below, the processor 120, based upon the received information, can determine target areas around the vehicle to look for target objects.

The object perception system 110 may further include one or more host vehicle sensors 180. The host vehicle sensors 180 may track speed, acceleration and attitude of the vehicle 100 and provide the data to the processor 120. In instances where GPS data is unavailable, such as when the vehicle 100 is under a bridge, tunnel, in areas with many tall buildings, or the like, the processor 120 may use the data from the host vehicle sensors 180 to project a path for the vehicle 100, as discussed in further detail below. The host vehicle sensors 180 may also monitor turn signals of the vehicle 100. As discussed in further detail below, the turn signals may be used to help determine a possible path the vehicle 100 is taking.

The vehicle 100 further includes one or more safety and vehicle control features 190. The processor 120, when a potential collision is determined, may activate one or more of the safety and vehicle control features 190. The safety and vehicle control features 190 may include a warning system capable of warning a driver of a possible object for avoidance. The warning system could include audio, visual or tactile warnings, or a combination thereof to warn the driver. In other embodiments, for example, the one or more safety and vehicle control features 190 could include active safety systems which could control the steering, brakes or accelerator of the vehicle 100 to assist the driver in an avoidance maneuver. The vehicle 100 may also transmit warning data to another vehicle via the V2V radio system 140. In another embodiment, for example, the safety and vehicle control features 190 may activate a horn of the vehicle 100 or flash lights of the vehicle 100 to warn other vehicles or pedestrians of the approach of the vehicle 100.

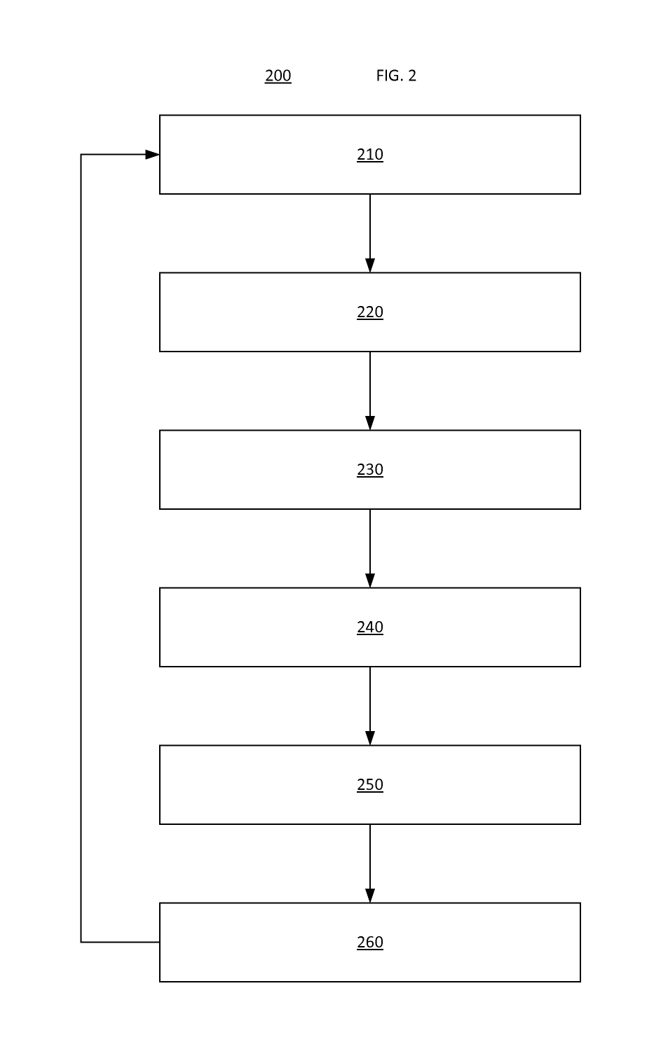

FIG. 2 is a flow diagram of a method 200 for operating an object perception system, such as the object perception system illustrated in FIG. 1, in accordance with an embodiment. A processor, such as the processor 120 illustrated in FIG. 1, first determines a position and attitude of the vehicle and a road the vehicle is traveling upon. (Step 210). As discussed above, a vehicle may include a GPS system and other sensors which together can be used to determine the location and attitude of the vehicle. The processor, based upon the location of the vehicle, then determines where the vehicle is relative to map data stored in a memory, such as the memory 160 illustrated in FIG. 1. Historical GPS data in conjunction with the map data can be used by the processor to determine the road the vehicle is traveling upon and the direction the vehicle is traveling on the road. If GPS data is temporarily unavailable, for example, if the vehicle is under a bridge, in a tunnel, near tall buildings, or the like, the processor may estimate a position of the vehicle. In one embodiment, for example, the processor may use the sensors on the vehicle to estimate a position and attitude of the vehicle. For example, the processor may monitor a distance of the vehicle relative to landmarks identifiable in images taken by the sensors. The landmarks could include street lights, stop signs, or other traffic signs, buildings, trees, or any other stationary object. The processor may then estimate a position of the vehicle based upon a previously known vehicle position, a dead-reckoning estimation (i.e., based upon a speed the vehicle is traveling and angular rates of change), and an estimated change in distance between the vehicle and the landmarks identified in the sensor data.

The processor then determines a projected path the vehicle will be taking (Step 220). Navigation information input by the user, when available, may be used to determine the projected path. However, when navigation information is unavailable, the processor may determine a projected path based upon data from one or more of the sensors on the vehicle and/or from the information determined in 210.

The projected path may be based upon which lane the vehicle is in. In one embodiment, for example, the processor may determine or verify which lane a vehicle is in based upon an image from a camera. In another embodiment, for example, the processor may determine a lane which the vehicle is traveling upon based upon the position of the vehicle indicated by the GPS and map data of the road the vehicle is traveling upon stored in a memory. If the vehicle is determined to be in a left only turn lane, the projected path would be to turn left. Likewise, if the vehicle is determined to be in a right only turn lane or a straight only lane, the projected path would be to turn right or go straight through an intersection, respectively. If a vehicle could go in multiple directions in a lane, the processor may determine a path depending upon a speed of the vehicle. For example, if the vehicle could turn right or stay straight in a given lane, the processor may project a path to turn right if the vehicle is slowing down. In this embodiment, for example, the processor may also utilize a camera (i.e., a sensor) on the vehicle to determine a status of a traffic light and/or traffic around the vehicle. If the traffic light is green, signaling that the vehicle can proceed into the intersection, and the vehicle is slowing down, the processor may project that the vehicle is turning right. Likewise, if the traffic in front of the vehicle is not slowing down, the light is green and the vehicle is slowing down, the processor may project that the vehicle is planning on turning. The processor may further utilize turn signal data to determine the projected path of the vehicle. If a right turn signal is on, for example, the processor may project the vehicle to turn right at the next intersection. Likewise, if no turn signal is currently on and/or the vehicle is not slowing down for a green light, the processor may determine that the projected path is to go straight through the intersection. If no projected path can be determined, the processor may prioritize target areas for multiple possible paths, as discussed in further detail below.

The processor then prioritizes target areas for the sensors on the vehicle. (Step 230). The processor utilizes location and attitude data, map information, and direct sensor data to categorize the current driving environment and/or situation into one of several defined categories, each of which has prototypically distinct driving dynamics, threat likelihoods and typical characteristics, and sensing limitations. For example, in the freeway driving environment, absolute speeds are high while relative speeds are typically low, perpendicular cross-traffic should not exist, so threats are only likely to appear from an adjacent lane, shoulder, or on-ramp, and pedestrian or animal crossings should be relatively rare; conversely, in dense urban neighborhoods, vehicle speeds are generally low although relative speeds may be occasionally quite high, perpendicular cross-traffic is common, and potential conflict with pedestrians is relatively likely. The nature of each specific driving environment instructs the prioritization of various geometric areas around the vehicle and scaling of sensor usage, including resolution, sampling frequency, and choice of sensor analysis algorithms. Accordingly, while the sensors of the vehicle may be capable of monitoring the surroundings of the vehicle in all 360 degrees, certain areas should be monitored more closely than others. The areas may be defined in a multitude of ways, for example, as two-dimensional grid of rectilinear regions of fixed or varying sizes, or as a radial array of arc-shaped ring subsections at various radii, or as a list of closed polygons each specified by a list of vertex coordinates. The processor prioritizes target areas based upon the driving environment and/or situation the vehicle is in. There are a multitude of situations the vehicle could be in.

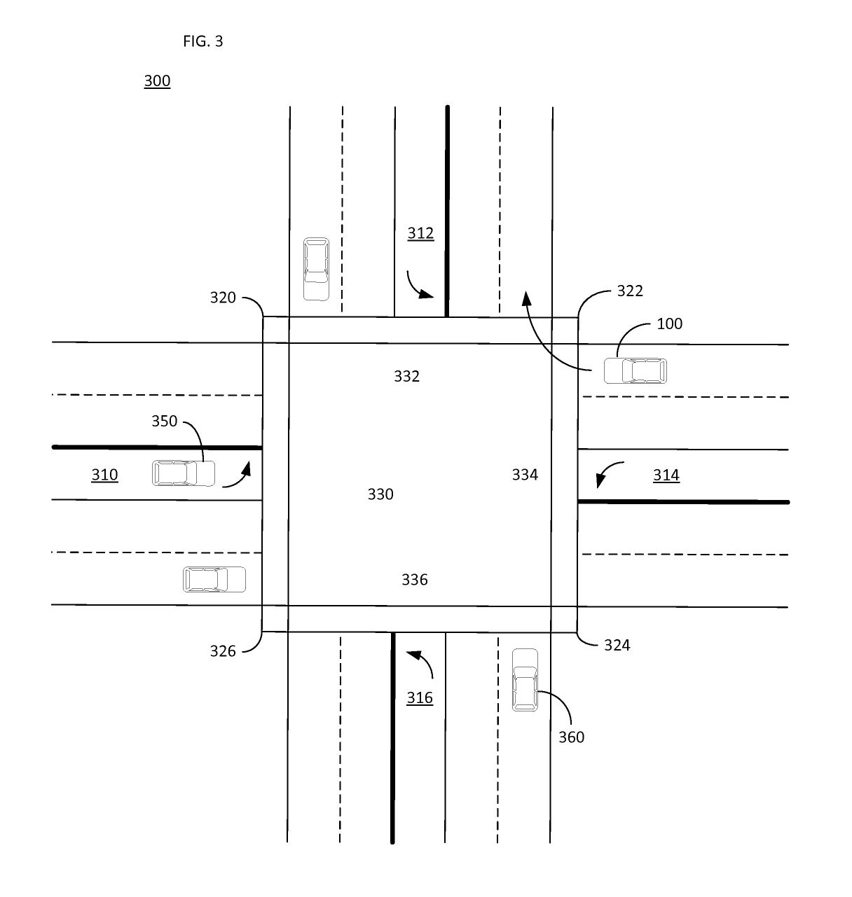

With brief reference to FIG. 3, FIG. 3 is an overhead view of an exemplary intersection 300, in accordance with an embodiment. The intersection has left turn lanes 310-316, traffic lights including pedestrian crossing signals 320-326, and pedestrian walking paths 330-336. In this embodiment, the vehicle 100 having an object perception system 110 is projected to turn right at the intersection 300 as indicated by the arrow 340. Accordingly, in this particular situation, the vehicles 350, being in a left turn lane 310, and the vehicle 360 being in an indeterminate (right turn lane or straight lane) could potentially cross paths with the vehicle 340. Furthermore, pedestrians in the pedestrian paths 332 and 334 could potentially cross paths with the vehicle 340. Accordingly, in this embodiment, the processor 120 would prioritize the monitoring of vehicles 350 and 360, other vehicles in their respective lanes, and pedestrian paths 332 and 334.

When a vehicle is, for example, on a highway, the processor 120 may prioritize drivable roadways and shoulders, while deemphasizing rear areas unless planning or expecting a lane change maneuver. When a vehicle is, for example, in a rural or woodland area, the processor 120 may prioritize infrared camera sensors (if equipped), while deemphasizing lidar to the side of the vehicle which will mostly illuminate vegetation. When a vehicle is, for example, in an Urban/suburban residential neighborhood, the processor 120 may increase priority of cross traffic and adjacent areas, increase the priority of forward radar and perpendicular lidar (pedestrians, vehicles pulling into roadway), and blind zone radar/lidar. When a vehicle is, for example, driving though fog, rain or snow the processor 120 may increase priority of a forward zone, increase emphasis of infrared or radar-based sensors, while decreasing reliance on visible light cameras and some lidar systems. When a vehicle is driving in reverse, for example, the processor 120 may increase priority of entire rear area and decrease priority of forward area, emphasize radar, ultrasonic rangefinders, lidar, and/or vision system (if equipped for rear view). In one embodiment, for example, a table of possible situations and corresponding target prioritizations may be stored in a memory, such as the memory 160 illustrated in FIG. 1. The processor may determine which of the possible situations most closely resembles the situation the vehicle is in and base the prioritizations therefrom.

Returning to FIG. 2, the processor can prioritize target areas in a variety of ways. In one embodiment, for example, target areas with higher priority may have a higher refresh rate than areas of low priority. An optical camera, lidar or radar, for example, may continuously produce images of an intersection. The areas in an image corresponding to prioritized target areas may be analyzed in each frame. Areas in an image corresponding to lower prioritized target areas may be analyzed less frequently (i.e., at a low frequency), for example, every five frames of images the camera.

In another embodiment, for example, when the vehicle has sensors placed around the vehicle, sensors that are directed towards an area where a high prioritized target area is present may be run at a higher resolution and/or sample rate than sensors directed towards an area with only lower prioritized target areas. In one embodiment, for example, if the sensor(s) are optical cameras, images from optical cameras pointed at areas with only lower priority targets may be taken at a lower resolution (i.e., fewer pixels) than images from optical cameras pointed at areas with high priority targets. In certain situations, the processor could also turn some of the sensor(s) 130 off. If, for example, the vehicle is in a rightmost lane and there are no upcoming intersections, the sensor(s) on the right side of the car may be temporarily disabled by the processor to reduce the amount of data required to be analyzed by the system.

The processor then analyzes the data from the sensor(s) according to the prioritization. (Step 240). The processor, for example, may detect and monitor objects in the sensor data and determine if an avoidance maneuver is necessary by the host vehicle. By dynamically prioritizing target areas for the processor to monitor, the system minimizes the latency for detecting objects that may result in the need for an avoidance maneuver. Accordingly, the system can detect high risk objects more quickly, giving warning to a driver sooner or activating driver assistance system more quickly. Furthermore, the computational horsepower required to detect high risk objects and the latency for finding the high risk objects is reduced relative to systems which perform a full 360 degree analysis.

If the processor detects a possible or imminent event for avoidance (anything else the processor looks for?), in one embodiment, the processor activates a response system (Step 250). The processor, for example, may project a path of a target object based upon multiple readings of the sensor(s). If the projected path of the target object intersects a path of the vehicle or is projected to be within a predetermined distance of the projected path of the host vehicle, the processor may indicate a possible or imminent event for avoidance. In this example, the processor may brake the vehicle, accelerate the vehicle, steer or turn the vehicle or any combination thereof to help the vehicle avoid the object. The processor could also activates warning systems for other vehicles or pedestrians, for example, by transmitting a warning via a V2V radio system, flashing lights of the vehicle or activating a horn of the vehicle.

If a chance of the need to avoid an object exists, but the object was in a low priority target area, the processor may elevate the area to a prioritized target area or redefine the boundaries of a current high-priority area in subsequent passes through the processes flow of the system. (Step 260).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for dynamically prioritizing target areas to monitor around a vehicle, comprising:
determining, by a processor, a location, heading and attitude of the vehicle and a path the vehicle is traveling upon;
prioritizing, by the processor, target areas based upon the determined location, heading, attitude and path; and
analyzing, by the processor, data from at least one sensor based upon the prioritizing.

2. The method of claim 1, wherein the prioritizing further comprises prioritizing target areas based upon a lane the vehicle is traveling in.

3. The method of claim 1, wherein the determining further comprises determining the path based upon navigation data.

4. The method of claim 1, wherein the determining further comprises determining a driving environment based upon a plurality of categories, each category having prototypical threat characteristics, driving dynamics, and sensing limitations.

5. The method of claim 4, wherein the prioritizing comprises identifying at least one high priority target area and at least one low priority target area based upon the determined location, attitude, driving environment, and path.

6. The method according to claim 4, wherein the analyzing further comprises analyzing, by the processor, high priority target areas at a first resolution and low priority target areas at a second resolution, wherein the first resolution is higher than the second resolution.

7. The method according to claim 4, wherein the analyzing further comprises analyzing, by the processor, high priority target areas at a first frequency and low priority target areas at a second frequency, wherein the first frequency is higher than the second frequency.

8. The method according to claim 4, wherein the analyzing further comprises analyzing, by the processor, high priority target areas at a first level of and low priority target areas at a second level of analysis and completeness, wherein the first level of analysis is more extensive than the second level.

9. The method according to claim 1, further comprising updating, by the processor, target areas based upon the analyzed data.

10. A vehicle, comprising:
a sensor;
a source of global positioning system data; and
a processor communicatively coupled to the sensor and the source of global positioning system data, wherein the processor is configured to:
determine a location, heading and attitude of the vehicle and based upon data from the source of global positioning system data;
determine a projected path the vehicle is traveling upon;
prioritize target areas based upon the determined location, heading, attitude and the projected path; and
analyze data from the sensor based upon the prioritized target areas.

11. The vehicle according to claim 10, wherein the processor is further configured to prioritize target areas based upon a lane the vehicle is traveling in.

12. The vehicle according to claim 10, wherein the processor is further configured to recognize and prioritize target areas based upon a driving environment.

13. The vehicle according to claim 10, wherein the processor is further configured prioritize target areas by identifying at least one high priority target area and at least one low priority target area based upon the determined location and the projected path.

14. The vehicle according to claim 13, wherein the processor is further configured to analyze high priority target areas at a first resolution and low priority target areas at a second resolution, wherein the first resolution is higher than the second resolution.

15. The vehicle according to claim 13, wherein the processor is further configured to analyze high priority target areas at a first frequency and low priority target areas at a second frequency, wherein the first frequency is higher than the second frequency.

16. The vehicle according to claim 13, wherein the processor is further configured to analyze high priority target areas at a first level of analysis and low priority target areas at a second level of analysis and completeness, wherein the first level of analysis is more extensive than the second level.

17. A system for dynamically prioritizing target areas to monitor around a vehicle, comprising:
a sensor;
a global positioning system receiver for providing global positioning data; and
a processor communicatively coupled to the sensor, and the global positioning system receiver, wherein the processor is configured to:
determine a location of the vehicle and based upon the global positioning data from the global positioning system receiver;
determine a projected path the vehicle is traveling upon;
prioritize target areas based upon the determined location and the projected path; and
analyze data from at the sensor based upon the prioritized target areas.

18. The system according to claim 17, wherein the processor is further configured prioritize target areas by identifying at least one high priority target area and at least one low priority target area based upon the determined location, a driving environment, and the projected path.

19. The system according to claim 18, wherein the processor is further configured to analyze high priority target areas at a first resolution and low priority target areas at a second resolution, wherein the first resolution is higher than the second resolution.

20. The system according to claim 18, wherein the processor is further configured to analyze high priority target areas at a first frequency and low priority target areas at a second frequency, wherein the first frequency is higher than the second frequency.
